(19) United States
(12) Patent Application Publication
(10) Pub. No.: US 2025/0076327 A1
(43) Pub. Date: Mar. 6, 2025

(54) Sample preparation workstation and sample preparation system

(71) Applicant: SHENZHEN JINGTAI TECHNOLOGY CO., LTD., Shenzhen (CN)

(72) Inventors: Weibo LI, Shenzhen (CN); Ruibin MAI, Shenzhen (CN); Jian WANG, Shenzhen (CN); Anxin HOU, Shenzhen (CN); Yongkang WANG, Shenzhen (CN); Weiwei LIU, Shenzhen (CN); Yangli OU, Shenzhen (CN); Yang LIU, Shenzhen (CN); Jiandong GAO, Shenzhen (CN)

(21) Appl. No.: 18/575,207

(22) PCT Filed: Jul. 12, 2023
(86) PCT No.: PCT/CN2023/106937

§ 371 Date: Dec. 28, 2023

(30) Foreign Application Priority Data
Jul. 15, 2022 (CN) 202210833216.0

(51) Int. Cl. G01N 35/00; G01N 35/10

(52) U.S. Cl. CPC G01N 35/0099; G01N 35/10

(57) ABSTRACT

The present disclosure relates to the technical field of automation equipment and specifically discloses a sample preparation workstation and a sample preparation system. The sample preparation workstation includes a preparation platform, a robotic arm mounted to the preparation platform, a sample exchange chamber mounted to the preparation platform and used for exchanging a sample before or after experiment with the outside world, a transfer tool mounted to the robotic arm, and an experimental apparatus mounted to the preparation platform. The robotic arm drives the transfer tool to move so that the transfer tool transfers the sample before experiment in the sample exchange chamber to the experimental apparatus for experiment and transfers the sample after experiment to the sample exchange chamber. According to an embodiment of the present disclosure, the full-automatic sample preparation can be realized, the labor cost can be saved and the experiment efficiency can be improved.

### CROSS-REFERENCE TO RELATED APPLICATIONS

The present application claims priority to Chinese Patent Application No. 202210833216.0 filed with the China National Intellectual Property Administration on Jul. 15, 2022, entitled sample preparation workstation and sample preparation system, the contents of which are all incorporated herein by reference in their entireties.

### FIELD OF THE INVENTION

The invention relates to the technical field of automation equipment, in particular to a sample preparation workstation and a sample preparation system.

### DESCRIPTION OF THE RELATED ART

In automated experiments, the sample preparation process is usually complicated and requires multiple procedures to complete. At present, the procedures are mainly operated by human, and a large number of experimenters need to participate in the preparation process during the experiment, which not only influences the experimental efficiency and causes a longer preparation period, but influences the experimental accuracy as well. In addition, in the related art, the laboratory table corresponding to multiple procedures occupies a large area and needs a large experimental space.

### Technical Problem

The present disclosure provides a sample preparation workstation and a sample preparation system, which can realize the full-automatic sample preparation, save the labor cost and improve the experiment efficiency.

### SUMMARY

The present disclosure provides a sample preparation workstation which includes a preparation platform, a robotic arm mounted to the preparation platform, a sample exchange chamber mounted to the preparation platform and used for exchanging a sample before or after experiment with the outside world, a transfer tool mounted to the robotic arm, and at least one experimental apparatus mounted to the preparation platform. The robotic arm drives the transfer tool to move so that the transfer tool transfers the sample before experiment in the sample exchange chamber to the experimental apparatus for experiment and transfers the sample after experiment to the sample exchange chamber.

Furthermore, the sample preparation workstation includes a plurality of kinds of said transfer tools, and the sample preparation workstation further includes a tool magazine arranged on the preparation platform and used for storing the plurality of kinds of said transfer tools, each kind of the transfer tools being detachably connected with the robotic arm.

Furthermore, the sample preparation workstation includes a plurality of said experimental apparatuses which are distributed around the robotic arm, the robotic arm is arranged at a central position of the preparation platform, an experimental apparatus far away from the robotic arm is higher than an experimental apparatus close to the robotic arm, and the sample exchange chamber is arranged at an edge position of one side of the preparation platform.

Furthermore, the at least one experimental apparatus includes at least one of a powder adding device, an electromagnetic stirring device, an oscillation device, a dissolved clarification detecting device, a liquid level layering detection device and a filtering device. The powder adding device is configured to add a powder sample into the sample, the electromagnetic stirring device is configured to stir the sample, the oscillation device is configured to oscillate the sample, the dissolved clarification detecting device is configured to detect a uniformity degree of the sample, the liquid level layering detection device is configured to detect a layering state of the sample, and the filtering device is configured to filter the sample.

Furthermore, the transfer tools comprise a container transfer gripper. The at least one experimental apparatus includes a rotating module for cap opening and closing, the robotic arm is connected with the container transfer gripper, the container transfer gripper is configured to clamp a cap of a container for containing the sample, the rotating module is configured to clamp a body of the container, and the container transfer gripper and the rotating module are in cooperation with each other to perform a cap opening or closing operation on the container.

Furthermore, the transfer tools comprise a liquid transfer module. The at least one experimental apparatus includes a solvent storage, the robotic arm is connected with the liquid transfer module, and the robotic arm is configured to drive the liquid transfer module to move and add a solvent in the solvent storage into the sample through the liquid transfer module.

Furthermore, the sample preparation workstation further includes a temporary storage holder mounted to the preparation platform. The robotic arm drives the transfer tool to store the sample on the temporary storage holder. The temporary storage holder includes at least one layer of storage plate, the storage plate is provided with a first storage position for storing the sample, and the temporary storage holder is arranged at one side of the preparation platform.

Furthermore, the temporary storage holder further includes a connector arranged at the first storage position and configured to limit the sample at the first storage position. The connector is a step pin which is configured to be inserted into an insertion hole formed in a bottom of a tray with the sample. Or, the connector is an elastic member, the first storage position is a limiting slot, the elastic member is arranged in the limiting slot, and the elastic member can be abutted with a container with the sample and generate elastic deformation when the container is placed in the limiting slot.

Furthermore, the sample is contained in a container placed in a tray, and the transfer tools include a container transfer gripper and a tray transfer gripper. The sample preparation workstation further includes a transit holder mounted to the preparation platform, the robotic arm drives the tray transfer gripper to place the tray onto the transit holder, and the robotic arm drives the container transfer gripper to transfer the container in the tray to the experimental apparatus.

Furthermore, the temporary storage holder further includes a plurality of said transit holders with different heights. The higher a transit holder is, the farther it is from the robotic arm.

Furthermore, the transit holder includes a placing plate. The placing plate is provided with a step pin for being inserted into an insertion hole formed in a bottom of the tray; and/or the placing plate is provided with tray clamping members at both ends for clamping the tray.

Furthermore, the sample preparation workstation further includes a code reader mounted to the preparation platform and used for reading an identification code on the sample. The code reader is arranged close to the sample exchange chamber.

Furthermore, the sample exchange chamber includes a support assembly which is connected with the preparation platform, a holding plate which is connected to the supporting assembly and provided with at least two second storage positions for storing the samples, a positioner which is connected to the holding plate, corresponds to the second storage position and configured to limit the sample at the second storage position, and a sensor which is connected to the holding plate, corresponds to the second storage position, and is configured to sense whether a sample is placed at the second storage position.

Furthermore, the sample preparation workstation further includes a recycling assembly which is mounted to the preparation platform in a penetrating manner and is communicated with a recycling device under the preparation platform.

Furthermore, the sample preparation workstation further includes a main body which is arranged on the preparation platform and a station door arranged at the opening. An accommodation space having an opening at one side is defined by the main body and the preparation platform, and the robotic arm, the sample exchange chamber, the transfer tool and the experimental apparatus are all arranged in the accommodation space. The sample exchange chamber is arranged at one side close to the station door.

Furthermore, the sample preparation workstation further includes a three-axis calibration support which is connected to an outer wall of the main body and arranged at one side close to the station door and three identification code calibration plates. The three-axis calibration support includes an X-direction connecting plate, a Y-direction connecting plate and a Z-direction connecting plate which are perpendicular to each other in pairs, one end of the Y-direction connecting plate is connected with one end of the X-direction connecting plate, and the other end of the Y-direction connecting plate is connected with one end of the Z-direction connecting plate. Two of the identification code calibration plates are respectively arranged at two ends of the X-direction connecting plate, and the other identification code calibration plate is arranged at the other end of the Z-direction connecting plate. Each of the identification code calibration plates has an identification code arranged therein and used for locating the main body by a mobile equipment for externally carrying out sample taking and placing operation.

Furthermore, the station door includes a door frame, a lifting mechanism which is slidably connected to the door frame, a driving mechanism which is mounted to the door frame, connected to the lifting mechanism and configured to drive the lifting mechanism to slide relative to the door frame, and a door body which is connected to the lifting mechanism and matched with the door frame. The lifting mechanism is configured to drive the door body to slide relative to the door frame.

Furthermore, the station door further includes a weight, a pulley block and a connecting rope. The weight is slidably connected to the door frame. A sliding direction of the weight is parallel to that of the door body. The pulley block is mounted to the door frame. The connecting rope is wound on the pulley block. One end of the connecting rope is connected with the weight, and the other end of the connecting rope is connected with the lifting mechanism. When the driving mechanism drives the lifting mechanism to ascend, the pulley block and the connecting rope are in cooperation with each other to pull the weight to descend, and when the driving mechanism drives the lifting mechanism to descend, the pulley block and the connecting rope are in cooperation with each other to pull the weight to ascend.

Furthermore, the sample preparation workstation further includes a base and a display device. The base is connected to the preparation platform and located under the preparation platform. Control devices and electrical devices of the robotic arm and the experimental apparatus are placed in the base. The display device is mounted to the outer wall of the main body and configured for user checking and interaction.

Furthermore, the robotic arm is provided with a quick-change male connector, each of the transfer tools is provided with a quick-change female connector, and the quick-change male connector is matched with the quick-change female connector to detachably connect the robotic arm with the transfer tool.

Furthermore, the tool magazine is provided with a plurality of placing positions, and the number of the plurality of placing positions corresponds to the number of the transfer tools. The preparation platform is provided with communication holes which are matched with the plurality of placing positions, and the transfer tools can extend into the communication holes when being placed at the placing positions.

The present disclosure further provides a sample preparation system which includes a mobile equipment and any one of above-mentioned sample preparation workstations. The mobile equipment is configured to take samples from and place samples to the sample exchange chamber of the sample preparation workstation.

Furthermore, the sample preparation system includes at least two said sample preparation workstations. The mobile equipment is further configured for experimental interactions between the at least two said sample preparation workstations.

### Advantages

In the embodiment, the full-automatic sample preparation can be realized, which reduces the involvement of experimental operators and greatly reduces the labor cost in comparation with the related art. In addition, the precision of the device can ensure the dosage accuracy of the raw material of the sample and the accuracy of the sample preparation result during the sample preparation, the misoperation caused by human can be avoided

It should be understood that the foregoing general description and the following detailed description are illustrative and explanatory only and do not limit the present disclosure.

### BRIEF DESCRIPTION OF THE DRAWINGS

By providing a more detailed description of the exemplary embodiments of the present disclosure in combination with the accompanying drawings, the foregoing and other purposes, features, and advantages of the present disclosure will become more apparent. In the exemplary embodiments of the present disclosure, the same reference numerals usually represent the same components.

FIG. 1 is a three-dimensional view of the sample preparation workstation according to an embodiment of the present disclosure;

FIG. 2 is another three-dimensional view of the sample preparation workstation according to an embodiment of the present disclosure;

FIG. 3 is a view of a sample exchange chamber according to an embodiment of the present disclosure;

FIG. 4 is a view of a solvent storage according to an embodiment of the present disclosure;

FIG. 5 is a view of a temporary holder according to an embodiment of the present disclosure;

FIG. 6 is a view of a recycling assembly according to an embodiment of the present disclosure;

FIG. 7 is a view of a station door according to an embodiment of the present disclosure;

FIG. 8 is a view of a three-axis calibration support and three identification code calibration plates according to an embodiment of the present disclosure.

### DETAILED DESCRIPTION OF THE EMBODIMENTS

Some embodiments of the present disclosure will be described in more detail below with reference to the accompanying drawings. Although some embodiments of the present disclosure are shown in the accompanying drawings, it should be understood that the present disclosure can be implemented in various forms and should not be limited by the embodiments described here. On the contrary, these embodiments are provided to make the present disclosure more thorough and complete, and to fully convey the scope of the present disclosure to ones skilled in the art.

The terms used in the present disclosure are for the purpose of describing specific embodiments only and are not intended to be limit of the present disclosure. The singular forms of “a”, “said” and “the” used in the present disclosure and the accompanying claims are intended to include the plural forms as well, unless the context clearly indicates other meanings. It should also be understood that the term “and/or” used herein includes any or all possible combinations of one or more related listed items.

It should be understood that although the terms “first,” “second,” “third,” etc. may be used herein to describe various information, the information should not be limited to these terms. These terms are only used to distinguish the same type of information from each other. For example, without departing from the scope of the present disclosure, first information can also be referred to as second information, and similarly, second information may also be referred to as first information. Therefore, a feature defines as “first” or “second” can explicitly or implicitly include one or more of those features. In the description of the present disclosure, “a plurality of” means two or more, unless otherwise specified.

In the description of the present disclosure, it should be understood that the orientation or positional relationship indicated by the term “length”, “width”, “upper”, “lower”, “front”, “rear”, “left”, “right”, “vertical”, “horizontal”, “top”, “bottom”, “inner”, “outer” or the like is based on the orientation or positional relationship showing in the accompanying drawings and is only for the convenience of describing the present disclosure and simplifying the description, and do not indicate or imply that the device or element referred to must have a specific orientation, be constructed and operated in a specific orientation, and therefore cannot be understood as a limitation on the present disclosure.

Unless otherwise specified and limited, the terms “installation”, “couple”, “connection”, “fixation” or the like should be broadly understood. For example, the term “connection” can be a fixed connection, a detachable connection or as a whole, or can be a mechanical connection or an electrical connection, or can be directly connected or indirectly connected through an intermediate medium, or can be an internal connection between two components or an interaction relationship between two components. To a person skilled in the art, the specific meanings of the above terms in the present disclosure can be understood based on specific circumstances.

Technical solutions according to some embodiments of the present disclosure will be described in detailed in combination with the accompanying drawings.

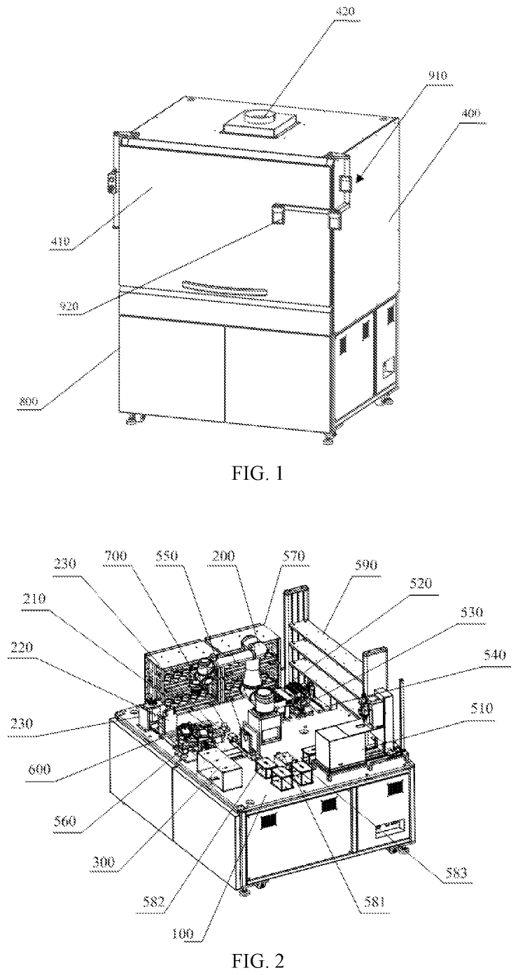

Referring to FIGS. 1 and 2, the sample preparation workstation according to an embodiment of the present disclosure includes a preparation platform 100, a robotic arm 200, a transfer tool mounted to the robotic arm 200, a sample exchange chamber 300, and an experimental apparatus. The robotic arm 200, the sample exchange chamber 300, and the experimental apparatus are all mounted on the preparation platform 100.

In a specific implementation, the sample preparation workstation is provided with a main body 400. The main body 400 is arranged on the preparation platform 100. An accommodation space having an opening at one side is defined by the main body 400 and the preparation platform 100. The robotic arm 200, the sample exchange chamber 300, the transfer tool and the experimental apparatus are all arranged in the accommodation space. A station door 410 is arranged at the opening. When the station door 410 is opened, the experimental requirements of the information interaction, the ventilation and the like between the inside environment and the outside environment of the preparation platform 100 can be realized. The station door 410 may be a turning door or a lifting door, which is not limited herein. The robotic arm 200 may be a three-axis, four-axis, or six-axis robotic arm. In addition, the main body 400 can be provided with a transparent visible window. For example, two side faces are made of transparent material. Thus, it is convenient for experimenters to intuitively know the working conditions of various experimental apparatus in the workstation so as to timely handle unexpected situations.

The sample exchange chamber 300 is used for exchanging samples before and after experiment with the outside world. The sample exchange chamber 300 may be used for placing a container with a sample, such as a reagent bottle, a test tube, a beaker, a flask or the like, or be used for placing a tray loaded with a plurality of said containers. The sample exchange chamber 300 is arranged at one side close to the station door 410, and mainly provides an exchange platform having multiple positions for material exchange between the inside and outside of the workstation. A mobile equipment or an experimenter external to the sample preparation workstation puts a container with a sample or a tray with the container onto the sample exchange chamber 300. The robotic arm 200 can take the container by clamping for experimentation. After the experiment is completed, the robotic arm 200 can put the container after experiment back onto the sample exchange chamber 300 for the external mobile equipment or experimenter to take away.

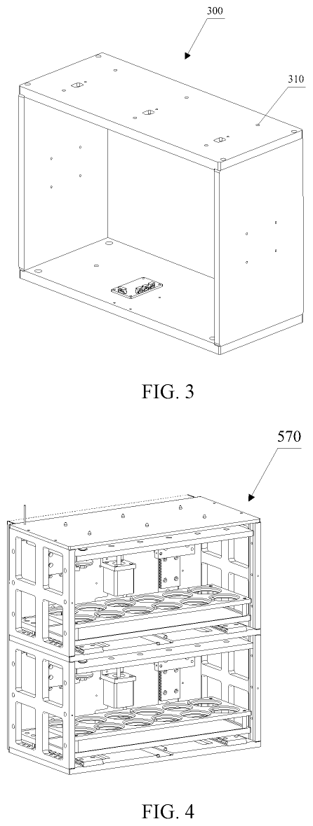

Referring to FIG. 3, in a specific implementation, the sample exchange chamber 300 includes a support assembly, a holding plate and positioners 310. The holding plate is connected to the support assembly and is provided with at least two second storage positions which are used for storing the samples. The positioners 310 are connected to the holding plate and correspond to the second storage positions. The positioner 310 is used for limiting the sample at the second storage position to prevent the sample from falling. For example, in the case that the second storage position is used for placing a tray, the positioner 310 may be matched with a fixing portion at the bottom of the tray to limit the tray at the second storage position. The sample exchange chamber 300 shown in FIG. 3 is provided with three second storage positions, and each second storage position can store a tray. Each second storage position is correspondingly provided with two positioners 310 which can be, for example, step pins, connecting posts or the like. Correspondingly, the bottom of the tray is provided with insertion holes into which the step pins or the connecting posts or the like are inserted, thereby fixing the tray on the sample exchange chamber 300. Of course, in specific implementations, the number of the storage positions of the sample exchange chamber 300 and the fixing manner of the tray may be determined according to actual situations. For example, tray clamping members are provided at two ends of the sample exchange chamber 300 to clamp the tray on the sample exchange chamber 300. For another example, in the case that the second storage position is used for placing a container, the second storage position may be a limiting slot formed in the holding plate. One limiting slot can limit one container. The positioner 310 may be an elastic member (e.g., a metal sheet or a POM plastic element with good elastic property) arranged on the inner wall of the limiting slot, and is used for being abutted with the body of the container and generating elastic deformation when the container is placed in the limiting slot, so as to clamp the container in the limiting slot and prevent the container from falling.

Specifically, the number of the second storage positions of the holding plate is preferably at least two. Thus, the requirement for receiving a large number of samples can be met, and the samples can be simultaneously taken from and placed on the holding plate as well. The working efficiency can be therefore improved.

In addition, the holding plate is further provided with sensors. The sensor is connected to the holding plate and corresponds to the second storage position. The sensor is used to sense whether a sample is placed at the second storage position. Each second storage position may have at least one sensor provided. In the case that the second storage position is used for placing a tray, the sensor may be arranged between the two positioners 310. In the case that the second storage position is used for placing a container, the sensor may be arranged in the limiting slot. After the sample is placed on the holding plate, the sensor can sense the existence of the sample and transmit the sensing information to the robotic arm 200 so that the sample can be timely taken away by the robotic arm 200. By providing the sensors, the robotic arm 200 can know the idle condition of each storage position of the sample exchange chamber 300 in real time, place the sample after experiment at the idle position when it is available, and timely take away the sample before experiment when no idle position is available. In a specific implementation, the sensor may be a photosensor, a pressure sensor or the like.

The robotic arm 200 drives the transfer tool to move so that the transfer tool transfers the sample before experiment in the sample exchange chamber 300 to the experimental apparatus for experimentation, and transfers the sample after experiment to the sample exchange chamber 300. The robotic arm 200 may be fixedly connected with the transfer tool, i.e. the transfer tool is integrated at one end of the robotic arm 200. Preferably, the robotic arm 200 and the transfer tool are detachably connected with each other. In a specific implementation, the robotic arm 200 is provided with a quick-change male connector, and the transfer tool is provided with a quick-change female connector. The quick-change male connector is matched with the quick-change female connector to detachably connect the robotic arm 200 with the transfer tool. Specifically, the quick-change male connector and the quick-change female connector can realize quick connection in a pneumatic connection manner, or in another connection manner such as magnetic connection or the like, which is not limited specifically herein.

It can be seen that, in the embodiment, the full-automatic sample preparation can be realized, which reduces the involvement of experimental operators and greatly reduces the labor cost in comparation with the related art. In addition, the precision of the device can ensure the dosage accuracy of the raw material of the sample and the accuracy of the sample preparation result during the sample preparation, the misoperation caused by human can be avoided, and high efficiency, safety and reliability of sample preparation can be realized. In addition, according to this solution, multiple procedures are integrated in a same workstation, which can not only improve the working efficiency, but save the experimental space as well.

In some embodiments, a plurality of kinds of transfer tools are included. The sample preparation workstation further includes a tool magazine 600 which is arranged on the preparation platform 100. The tool magazine 600 is used for storing the plurality of kinds of transfer tools. Each kind of transfer tool is detachably connected to the robotic arm 200. During an experiment, the robotic arm 200 can be equipped with different kinds of transfer tools according to different experimental procedures, and select different experimental apparatus to accomplish a series of actions required by the experiment.

In the case that a plurality of experiments are needed, a plurality of experimental apparatuses are correspondingly arranged in the sample preparation workstation. In order to save space occupied by the experiments, the layout of the sample preparation workstation is compact and some of the experimental apparatuses may be closely spaced, thus the robotic arm 200 may be prone to interference and collision with some experimental apparatuses as it moves. To solve this problem, in some embodiments, the plurality of experimental apparatuses are distributed around the robotic arm 200. The robotic arm 200 is arranged at a center position of the preparation platform 100. In addition, the experimental apparatus far away from the robotic arm 200 is higher than the experimental apparatus close to the robotic arm 200, so that the higher experimental apparatus can be prevented from interfering the lower experimental apparatus, making the robotic arm 200 perform operations on the experimental apparatus with different heights more smoothly, thereby improving the experimental efficiency to a certain extent while reducing the space for experiment and achieving high operational flexibility. In addition, the sample exchange chamber 300 is arranged at an edge of one side of the preparation platform 100, thus it can interact with the outside world more conveniently.

The experimental apparatuses include a powder adding device 510. The powder adding device 510 is used for adding a powder sample into a container containing a sample. The robotic arm 200 takes the container from the sample exchange chamber 300 by clamping and transfers the container to the powder adding device 510. The powder adding device 510 can accurately conduct automatic powder adding to the sample in the container. Specifically, the powder adding device 510 has a weighing unit integrated therein. The weighing unit is used for quantifying the powder adding so as to improve the precision of experiment.

The experimental apparatuses include an electromagnetic stirring device 520. The electromagnetic stirring device 520 is used for, according to the experiment requirements, stirring the sample reagent in the container at normal temperature or in cold or hot states by utilizing the magnetic force. In a specific implementation, the electromagnetic stirring device 520 can generate a periodically varying magnetic field, the container is provided with a magneton, the robotic arm 200 places the container onto the electromagnetic stirring device 520 by clamping, and the magneton in the container rotates under the induction of the periodically varying magnetic field so as to stir the sample reagent in the container. The electromagnetic stirring device 520 may further be provided with a temperature adjusting device which can adjust the temperature of the sample reagent in the container according to the experimental requirement.

The experimental apparatuses include an oscillation device 530. The oscillation device 530 is used for oscillating the sample reagent in the container. In a specific implementation, the oscillation device 530 is provided with a container holder for placing containers, and a vibration structure is arranged under the container holder. The vibration structure can be composed of a motor and eccentric shafts. Specifically, the motor is used for controlling three eccentric shafts to rotate to generate vibration to drive the container holder above the vibration structure to vibrate such that the oscillation experiment is performed on the sample reagent in the container.

The experimental apparatuses include a dissolved clarification detecting device 540. The dissolved clarification detecting device 540 is used for detecting the uniformity degree of the sample reagent. For example, an image of the sample reagent after oscillation experiment or after stirring experiment is obtained, and the uniformity degree, the crystalline state and the like of the sample reagent are determined according to the image. In a specific implementation, the dissolved clarification detecting device 540 include an imaging device for photographing images. The imaging device can move along three axis X, Y, Z. After the sample reagent in the container is oscillated by the oscillation device 530 or is stirred by the electromagnetic stirring device 520, the dissolved clarification detecting device 540 can be used to photograph an image from the bottom or top of the container on the oscillation device 530 or on the electromagnetic stirring device 520, and analyze the image to obtain the clarity, the crystalline state and other states of the sample reagent. Of course, the dissolved clarification detecting device 540 can be integrated with the container holder of the oscillation device 530 or with the container holder of the electromagnetic stirring device 520, and obtain the uniformity degree of the sample reagent through a laser sensor.

The experimental apparatuses include a liquid level layering detection device 55. The liquid level layering detection device 550 is used for detecting the layering state of the sample. For example, an image of the sample reagent in the container after the oscillation experiment or the stirring experiment is obtained, and the image is analyzed to obtain the layering state of the sample reagent. In a specific implementation, the liquid level layering detection device 550 can photograph the sample reagent in the container, and then perform image analysis and processing so that the result of the layering experiment can be observed.

The experimental apparatuses include a filtering device which is used for filtering the sample reagent.

In some embodiments, the sample preparation workstation includes any one of the above-described experimental apparatuses. In this case the workstation correspondingly performs a single experiment.

In some other embodiments, the sample preparation workstation may include two or more of the above-described experimental apparatuses to perform a desired sequence of actions for the experiment. For example, the experimental apparatuses include the powder adding device 510, the electromagnetic stirring device 520 and the liquid level layering detection device 550. The robotic arm 200 moves the container with the sample to the powder adding device 510 for powder adding operation, then moves the container after powder adding to the electromagnetic stirring device 520 for stirring, and then moves the container after stirring to the liquid level layering detection device 550 for layering detection.

In some other embodiments, the sample preparation workstation may include any two or more of the above-described experimental apparatuses or include all of the above-described experimental apparatuses. The robotic arm 200 selects different experimental apparatuses according to different experimental requirements. Therefore, in this embodiment, the function compatibility is strong, different functions can be flexibly and freely matched and combined, and the functional diversities and the high-flux operation of sample preparation can be realized. It can be understood that the experimental apparatuses in this embodiment is not limited to the above-described ones. It can be other kind of experimental apparatus, such as a centrifugal apparatus for centrifugal experiment, a magneton taking and placing apparatus which is in cooperation with the electromagnetic stirring apparatus for automatically taking the magneton from the container and placing the magneton into the container, a nitrogen blowing apparatus for sample concentration or the like. The corresponding experimental apparatus can be selected according to the experimental requirement. The workstation according to this embodiment has strong scalability and high flexibility.

In some embodiments, the transfer tools include a container transfer gripper 210, and the experimental apparatuses include a rotating module 560 for cap opening and closing. The robotic arm 200 is connected with the container transfer gripper 210. The container transfer gripper 210 is used for clamping the cap of the container for containing a sample. The rotating module 560 is used for clamping the body of the containers. The container transfer gripper 210 and the rotating module 560 are in cooperation with each other to perform cap opening and closing operations on the container. During the cap opening and closing operations, the container transfer gripper 210 clamps the cap immovably, and the rotating module 560 clamps the body to rotate so as to separate the body from the cap or tighten the body with the cap. The container transfer gripper 210 can clamp the container, primarily for cap opening and closing and transferring the container. The robotic arm 200 can transfer the container to a different experimental apparatus or transfer the container between different experimental apparatuses by using the container transfer gripper 210.

For example, the experimental apparatuses include the powder adding device 510, the oscillation device 530, the dissolved clarification detecting device 540, and the rotating module 560 for cap opening and closing. The robotic arm 200 moves the container with sample to the rotating module 560 by using the container transfer gripper 210 so as to open the cap. Next, by using the container transfer gripper 210, the robotic arm 200 moves the container with the cap removed to the powder adding device 510 for powder adding operation, and then moves the container with added powder to the oscillation device 530 for oscillation. Then the dissolved clarification detecting device 540 is used to detect uniformity degree. After the experiment is finished, the robotic arm 200 uses the container transfer gripper 210 to move the container to the rotating module 560 for cap closing, and then move the container to the sample exchange chamber 300 so that the container can be taken away.

In some embodiments, referring to FIGS. 2 and 4, the transfer tool includes a liquid transfer module 220, and the experimental apparatuses include a solvent storage 570. The robotic arm 200 is connected with the liquid transfer module 220, The robotic arm 200 drives the liquid transfer module 220 to move, and adds the solvent in the solvent storage 570 into the sample through the liquid transfer module 220. In a specific implementation, the solvent storage 570 is capable of storing a plurality of kinds of solvents simultaneously, and has a drawer-type structure. A plurality layers of solvent storages can be stacked and the number of the solvent storages can be increased or decreased according to different requirements. The solvent storage 570 can realize automatic opening, automatic extension, automatic retraction and automatic sealing of the solvent. The liquid transfer module 220 is mainly used for precise liquid transfer and transferring the solvent in the solvent storage 570 into the container with sample. The solvent storages 570 can be arranged in one or more groups. In order to facilitate liquid storage and liquid taking and avoid interference, the solvent storage 570 is arranged at one side of the preparation platform 100 and far away from other experimental apparatuses. No other experimental apparatus is arranged between the solvent storage 570 and the robotic arm 200 or the experimental apparatus with a lower height is arranged between the solvent storage 570 and the robotic arm 200, so that the interference can be avoided.

Specifically, the solvent storage 570 includes at least one layer of frame. The frame has a receiving chamber with an opening. A container carrying assembly for carrying containers is arranged in the receiving chamber. The container carrying assembly is provided with a plurality of container placing parts. The container carrying assembly is connected to the frame through a first moving mechanism which is used for driving the container carrying assembly to move in a straight line at the opening. A container sealing assembly is also arranged in the receiving chamber and is connected to the frame through a second moving mechanism. The container sealing assembly includes sealing mechanisms corresponding to the container placing parts. The second moving mechanism is used for driving the sealing mechanisms to be close to or away from the container placing parts so as to make the sealing mechanisms be in seal fit with or separate from mouths of the containers.

The first moving mechanism can drive the container carrying assembly to move linearly at the opening of the receiving chamber, for example, to move towards the outside of the receiving chamber or towards the inner side of the receiving chamber through the opening, which makes the liquid storing and liquid transferring operations more convenient. A plurality of containers in every layer of frame can be stably placed on the container carrying assembly, thus more containers can be stored in the space with same size and the space occupied by the containers can be reduced.

The container sealing assembly is located above the container carrying assembly. The second moving mechanism drives the container sealing assembly to be away from or close to the mouths of the containers. In the process of liquid transfer, it is not required to open and seal the plurality of containers one by one, and the operating time of the liquid transfer process can be reduced. The first moving mechanism and the second moving mechanism can be motors or air cylinders.

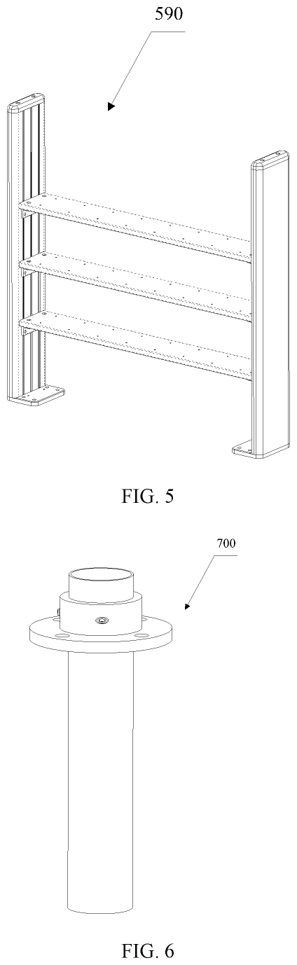

The sample exchange chamber 300 is used for interaction with the outside world. The outside samples to be tested and the samples after experiment are both stored in the sample exchange chamber 300. In order to solve the problem that the storage capacity of the sample exchange chamber 300 is limited and the experiment efficiency is therefore affected, in some embodiments, referring to FIGS. 2 and 5, the sample preparation workstation further includes a temporary storage holder 590 mounted to the preparation platform 100. The robotic arm 200 drives the transfer tool to place the samples on the temporary storage holder 590. The temporary storage holder 590 includes at least one storage plate which is provided with the first storage positions that are used for storing the samples. The temporary storage holder 590 is arranged at one side of the preparation platform 100. In order to avoid interference, no experimental apparatus is arranged between the temporary storage holder 590 and the robotic arm 200. Alternatively, the experimental apparatus with a lower height is arranged between the temporary storage holder 590 and the robotic arm 200, and specifically, the height of the experimental apparatus does not exceed the height of the storage plate of the temporary storage holder 590 closest to the preparation platform 100.

Furthermore, the temporary storage holder 590 further includes connectors arranged at the first storage positions. The connector is used for limiting the sample at the first storage position. The connector can be a step pin which is used for being inserted into an insertion hole formed at the bottom of the tray with samples. Alternatively, the connector can be an elastic member, the first storage position is a limiting slot, and the elastic member is arranged on the inner wall of the limiting slot. The elastic member can be abutted with the container and generate elastic deformation when the container with sample is placed in the limiting slot. Specifically, the elastic member can be a metal sheet, a POM plastic member with good elastic performance or the like.

Moreover, the temporary storage holder 590 further includes two supporting plates opposite each other. The storage plate is arranged between the two supporting plates. Specifically, the storage plate can be fixedly or slidably connected with the supporting plates. In the case that the storage plate is slidably connected with the supporting plates, at least one sliding slot can be formed in the supporting plate, a nut is arranged in the sliding slot, and the nut can move along the sliding slot. The storage plate has corner connectors fixed at both ends. The corner connector is connected with the nut through a bolt. By adjusting the position of the nut in the sliding slot before locking, the position of the storage plate can be adjusted, thus the storage plate can be suitable for the experimental samples with different heights.

When the sample exchange chamber 300 has no available storage position, the robotic arm 200 transfers the sample in the sample exchange chamber 300 to the temporary storage holder 590 for temporary storage. The temporary storage holder 590 may have a plurality of layers to store different numbers and/or different types of samples according to different requirements so as to relieve the storage pressure of the sample exchange chamber 300.

The sample is contained in the container placed in the tray. A plurality of containers can be simultaneously placed in a tray to improve the sample transfer efficiency. The transfer tools include a container transfer gripper 210 and a tray transfer gripper 230. The sample preparation workstation further includes a transit holder mounted to the preparation platform 100. The robotic arm 200 drives the tray transfer gripper 230 to place the tray onto the transit holder, and drives the container transfer gripper 210 to transfer the containers in the tray to the experimental apparatus one by one. As there are significant differences in size and shape between a tray and a container, it is usually hard for a single kind of gripper to carry two kinds of objects with significant differences. By providing special grippers to aimly carry the container and the tray, the security and the accuracy of the carrying can be improved, and the dropping or falling during the carrying can be avoided.

Specifically, the container transfer gripper 210 can be used for transferring containers and used for being in cooperation with the rotating module 560 to perform cap opening and closing operations on the container as well. The container transfer gripper 210 may have a single clamping jaw. The clamping surface of the clamping jaw can be in a V-shape. Or the clamping jaw consists of a plurality of cylindrical structures, such as four cylinders in parallel, which work together to perform container clamping and releasing. Alternatively, the container transfer gripper 210 may have clamping jaws at two sides, the clamping jaw at one side is a V-shaped structure and the clamping jaw at the other side is a structure consisting of four cylinders. The clamping jaws at two sides can be both used for container clamping and releasing. When performing the cap opening or closing operation, the clamping jaw at one side is used to clamp the container, and then the clamping jaw at the other side is switched to clamp the cap. For example, the V-shaped clamping jaw is used to clamp the container, and the clamping jaw with cylinders is used to clamp the cap.

The tray transfer gripper 230 is used to carry a tray, such as a tray for test tubes, a tray for solvent bottles, a tray for Tip heads or the like. The tray transfer gripper 230 includes a driving member, a first gripper arm and a second gripper arm. The first gripper arm and the second gripper arm are connected with the driving member respectively. The driving member can drive the first gripper arm and the second gripper arm to move close to or away from each other. A first gripper finger is arranged at one end of the first gripper arm far away from the driving member. The first gripper arm is connected with the first gripper finger in a floatable way. Elastic members are arranged between the first gripper arm and the first gripper finger, and two ends of the elastic member are abutted with the first gripper arm and the first gripper finger respectively. A second gripper finger is arranged at one end of the second gripper arm far away from the driving member. The second gripper arm is connected with the second gripper finger in a floatable way. Elastic members are arranged between the second gripper arm and the second gripper finger, and two ends of the elastic member are abutted with the second gripper arm and the second gripper finger respectively. Specifically, the elastic members can be springs spaced from each other. Alternatively, the elastic member can be an elastic sheet, a rubber block or the like. By floatably connecting the gripper finger to the gripper arm, when the clamping surface of the gripper finger is slightly unparallel to the tray, the gripper finger can adjust the clamping direction to successfully clamp the tray, thus the tray will not fall off during the clamping and transferring.

The transit holder may include a placing plate. The placing plate may be provided with step pins used for being inserted into insertion holes formed in the bottom of the tray with sample. Alternatively, tray clamping members can be arranged at both ends of the placing plate. Of course, the placing plate can have the step pins arranged thereon, and also have the tray clamping members arranged at two ends. By providing the step pins and/or the tray clamping members on the placing plate, the situation where the robotic arm 200 also lifts up the tray when taking the sample and the caused risk that the tray drops or the container falls can be avoided. The robotic arm 200 transfers the tray in the sample exchange chamber 300 onto the transit holder, and clamps the container from the tray on the transit holder to the experimental apparatus for experiment.

Furthermore, one or more transit holders may be provided. In the case that a plurality of transit holders with different heights are provided, the higher a transit holder is, the farther it is from the robotic arm 200. Thus, the problem that the robotic arm 200 is prone to interference and collision during taking and placing, which is caused by the compact layout in the sample preparation workstation, can be solved.

In a specific implementation, referring to FIG. 2, the transit holder may include at least a first tray frame and a second tray frame 581. The first tray frame and the second tray frame 581 are both mounted to the preparation platform 100. Referring to FIG. 2, the first tray frame and the second tray frame 581 may be single-connection type tray frames, i.e., tray frames for placing a single one tray. The placing plate of the first tray frame can be provided with two step pins for being matched with the pin holes at the bottom of the tray to position the tray. The first tray frame can be used for placing a tray for test tubes, a tray for solvent bottles or the like. The placing plate of the second tray frame 581 can be provided with two step pins for be matched with the pinholes at the bottom of the tray to position the tray, and the placing plate may also have tray clamping members arranged at both ends for clamping the two ends of the tray when the tray is placed on the placing plate, such that the tray can be fixed. The second tray frame 581 can be used for placing a tray for tip heads, a tray for filter heads or the like. As the robotic arm 200 can easily lift up the tray together during the lifting process after clamping the tip head or filter head, the tray clamping members are provided, such that the tray can be clamped and will not be lifted up by friction force.

Referring back to FIG. 2, the first tray frame and the second tray frame 581 may have frames with different heights. For example, the first tray frame includes the tray frame 582 with the height of 90 mm and the tray frame 583 with the height of 120 mm. The tray frame 583 with the height of 120 mm is far away from the robotic arm 200 and the tray frame 582 with the height of 90 mm is close to the robotic arm 200. Such a design and layout of different heights can not only avoid interference and collision between trays, but is convenient for the robotic arm 200 to clamp as well. The second tray frame 581 may also have a plurality of tray frames with different heights, which is not particularly limited herein.

In the case that two or more experimental apparatuses are included, in order to determine the experiment types corresponding to different samples, in some embodiments, the tray or the container is provided with an identification code, such as a bar code, a two-dimensional code or the like. Accordingly, the preparation platform 100 is provided with a code reader which is used for reading the identification code on the sample. In order to facilitate the robotic arm 200 to timely know the experiment to be performed on the sample after taking the sample, the code reader can be arranged near the sample exchange chamber 300. The code reader determines the experiment type according to the identification code and sends the experiment type to the robotic arm 200. The robotic arm 200 transfers the sample to the corresponding experimental apparatus for experimentation according to the experiment type.

The robotic arm 200 can also determine the object to be clamped according to the experiment type and the corresponding experiment procedures, and then has the corresponding transfer tool mounted thereto. For example, referring to FIG. 2, the tray transfer gripper 230 is mounted when a tray needs to be clamped, the container transfer gripper 210 is mounted when a container needs to be clamped, and the liquid transfer module 220 is mounted when the liquid transfer operation is needed, and so on.

The tool magazine 600 can be provided with a plurality of placing positions, and the number of the placing positions matches that of the transfer tools. The preparation platform 100 is provided with a plurality of communication holes which are matched with the plurality of placing positions. The transfer tools can extend into the communication holes when being placed at the placing positions. As the arrangement space available for the preparation platform 100 is limited, in some embodiments, the tray transfer gripper 230, the container transfer gripper 210, and the liquid transfer module 220 are all mounted to the tool magazine 600. The tool magazine 600 and the preparation platform 100 are both provided with insertion holes corresponding to the tray transfer gripper 230, the container transfer gripper 210 and the liquid transfer module 220, such that the tray transfer gripper 230, the container transfer gripper 210 and the liquid transfer module 220 can at least partially extend into the space under the preparation platform 100, thereby saving the arrangement space of the preparation platform 100. Specifically, every placing position is provided with a limiter. When each transfer tool is placed at the placing position, the limiter is matched with the transfer tool to stably store the transfer tool in the tool magazine 600.

When the transfer tool is placed at the placing position, some part of its structure may protrude from the top surface of the placing position. Therefore, in order to avoid interference when the robotic arm 200 switches the transfer tools in the tool magazine 600, the higher a transfer tool protrudes from the top surface of the placing position, the farther it is from the robotic arm 200.

In some embodiments, as shown in FIG. 2, the experimental apparatus includes the powder adding device 510, the electromagnetic stirring device 520, the oscillation device 530, the dissolved clarification detecting device 540, the liquid level layering detection device 550, the rotating module 560 for cap opening and closing, and the solvent storage 570. Specifically, the solvent storage 570, the tool magazine 600, the rotating module 560, the liquid level layering detection device 550, the sample exchange chamber 300, the code reader, the transit holder, the powder adding device 510, the oscillation device 530, the dissolved clarification detecting device 540 and the electromagnetic stirring device 520 sequentially surround the robotic arm 200. The above-described arrangement refers to the heights and the sizes of various apparatuses and devices and the consistency of experimental operations, and therefore can save the space and improve the experimental efficiency as much as possible.

Referring to FIGS. 2 and 6, in some embodiments the sample preparation workstation further includes a recycling assembly 700 which is mounted to the preparation platform 100 in a penetrating manner and is communicated with a recycling device under the preparation platform 100 so as to recycle the discarded solution, containers, tip heads, filter heads and the like into the recycling device.

It should be understandable that the sample preparation workstation may further include a base 800. The base 800 is connected to the preparation platform 100 and located under the preparation platform 100. The base 800 is a hollow shell, and its inner space can accommodate the control devices and the electrical devices of the robotic arm 200 and the experimental apparatuses, such as the electrical box, the computer host, the control box of the robotic arm and the like. The outer wall of the main body 400 may further be provided with a display device (not shown in the figures) which can be used by a user to check experimental conditions in the workstation and/or to interact with various devices in the workstation, such as manually inputting operation instructions, changing experimental procedures and the like. In addition, the base 800 is further provided with a plurality of cooling fans for cooling the electrical and control devices in the base 800. The controllers of the cooling fans are also located in the base 800.

The recycling assembly 700 is mainly used for recycling the discarded tip heads after liquid transfer. The upper port of the recycling assembly 700 protrudes from the preparation platform 100, and the lower port of the recycling assembly 700 extends into the space under the preparation platform 100, namely into the base 800, so that the discarded objects are thrown into the recycling device under the base 800 through the recycling assembly 700.

An example of experimental procedures of this embodiment will be illustrated as follow.

Firstly, the reagents, powders, instruments (such as filter heads, tip heads and the like) and the like which are used for preparing samples are placed on the sample exchange chamber 300 by an external experimenter or a mobile equipment. The robotic arm 200 selects different quick-change gripper tools from the tool magazine 600 according to different samples and moves the different samples to corresponding positions in the station after the identification codes of the different samples are read and identified by the code reader. The robotic arm 200 selects the corresponding gripper tool according to the size of container to move the container to the rotating module 560 for cap opening. Then the liquid adding operation is performed according to the experiment requirement. If powder adding is needed, the robotic arm 200 places the container on the powder adding device 510 and the needed amount is accurately added according to the preparation requirement. After the powder adding and liquid adding are completed, the robotic arm 200 can move the container to the electromagnetic stirring device 520 and the oscillation device 530 for stirring and oscillation. After the oscillation is completed, the dissolved clarification detecting device 540 detects the reagent after oscillation. If the layering state of the liquid need to be observed, the robotic arm 200 can place the reagent in the liquid level layering detection device 550 for detection. After all preparation operations are completed, the robotic arm 200 moves the finished reagent to the sample exchange chamber 300 for being taken away by an external experimenter or a mobile equipment for subsequent operations.

The entire workstation includes the functions of reagent carrying, reagent storage, cap opening, liquid transferring, powder adding, oscillation, detection and the like. These functions can be arranged and combined according to different experimental requirements to realize the automation of preparation. A plurality of function positions are designed in the workstation for realizing the function diversities and high-flux operation of the sample preparation.

In some embodiments, a ventilation window 420 is formed in the top plate of the main body 400. The ventilation window 420 is connected to an external exhaust gas processing device through a pipe such that the exhaust gas generated during experiment can be discharged through the ventilation window 420.

In some embodiments, an emergency stop device for stopping the operation of the robotic arm 200 and/or the experiment apparatus can be provided on the main body 400. By providing the emergency stop device, the experimenter can press an emergency stop button of the emergency stop device to stop the experiment when an accident happens.

In some embodiments, the sample preparation workstation further includes a state indicating device, such as a signal light, which may be arranged on an upper part of the main body 400 or on the base 800 for generating different signals to indicate the operation states of the workstation. For example, the state indicating device emits a green signal to indicate that the current state of the workstation is normal, emits a yellow signal to indicate that the current state of the workstation is stop, and emits a red signal to indicate that the current state of the workstation is abnormal.

In some embodiments, the sample preparation workstation is further provided with at least one monitoring device, such as a camera. Specifically, the monitoring device may be arranged at the inner side of an upper part of the main body 400. By providing the monitoring device, the experimenter can remotely check the experimental conditions in the workstation.

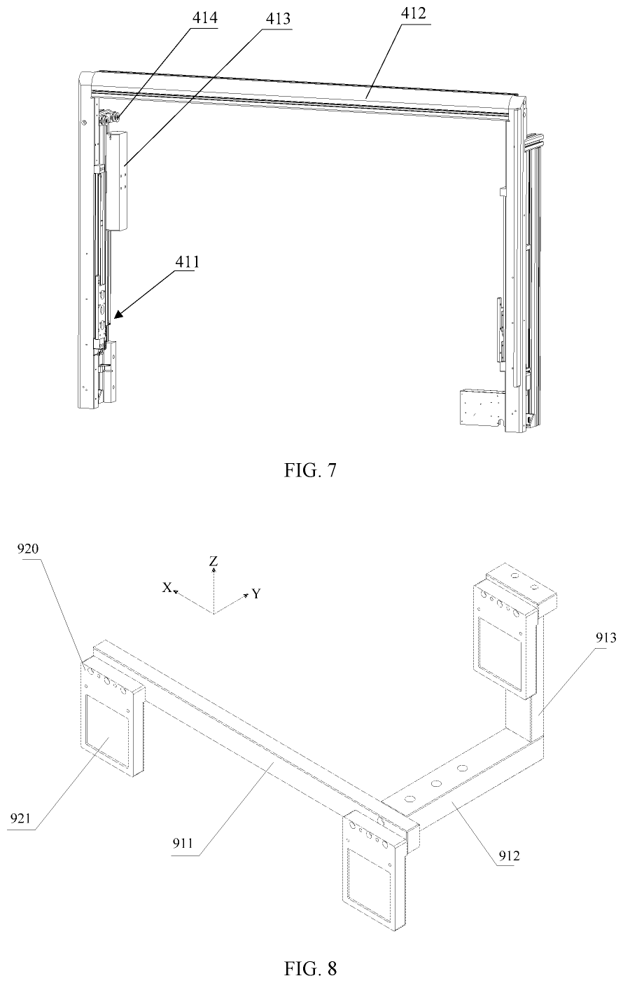

In some embodiments, referring to FIG. 7, the station door 410 is a lifting door. The station door 410 includes a door frame 412, a lifting mechanism 411, a driving mechanism and a door body.

The lifting mechanism 411 is slidably connected to the door frame 412. In a specific implementation, the lifting mechanism includes two lifting units. The two lifting units are arranged opposite each other and are both slidably connected to the door frame 412. The door body is arranged between the two lifting units and is connected with the two lifting units. The two lifting units simultaneously drive the door body to slide relative to the door frame 412. The driving mechanism is mounted to the door frame 412 and is connected to the lifting mechanism 411. The driving mechanism is used for driving the lifting mechanism 411 to slide relative to the door frame 412.

In a specific implementation, corresponding to the two lifting units, the driving mechanism includes two driving units. The two driving units are respectively connected with the two lifting units in a one-to-one correspondence manner. The driving units are used for driving the lifting units to slide relative to the door frame 412. The driving unit may be a motor, a hydraulic mechanism, a pneumatic mechanism, or the like, and this embodiment does not limit the specific form of the driving unit. It can be understood that a control mechanism is also included. The control mechanism is electrically connected to the two driving units and used for controlling the operation states of the two driving units. Specifically, the control mechanism may be mounted on the door frame 412.

The door body is matched with the door frame 412. The door body is connected to the lifting mechanism 411. The lifting mechanism 411 is used for driving the door body to slide relative to the door frame 412 to open or close the door body. The two lifting units are respectively arranged at two sides of the door body and connected with the door body. In a specific implementation, the connection between the door body and the lifting unit is a detachable connection, such as a bolt connection. The driving mechanism can control the lifting mechanism 411 to control the door body to stop at any position within the sliding range, so as to adjust the opening degree of the door body relative to the door frame 412.

In a specific implementation, the driving mechanism can be a lead screw motor. The lifting mechanism 411 is connected with the nut mounting seat of the lead screw motor. By controlling the rotation turn number of the lead screw motor, the nut mounting seat is correspondingly moved to a corresponding position, namely a stop position controlled by the lifting mechanism 411. In this way, the door body can be stopped at any position, and the opening degree of the door body relative to the door frame 412 can be adjusted freely.

In the related art, the state of the door body relative to the door frame 412 can only be fully closed or fully open. However, some experiments have the requirement to the ventilation volume, and the experimental results will be seriously affected if the ventilation volume cannot meet the requirement. The lifting door in the related art cannot adjust its opening degree, thus the ventilation volution cannot be adjusted. In this embodiment, the driving mechanism can control the lifting mechanism to stop at any position within the sliding range so as to adjust the opening degree of the door body relative to the door frame 412.

During experiment, the opening degree of the door body can be adjusted according to the ventilation requirements of different experiments, thus the air intake volume can be adjusted to achieve better ventilation effect.

Each lifting unit includes a first guide rail, a connecting plate and a limiting mechanism. The first guide rail is arranged on the door frame 412. The connecting plate is slidably connected to the first guide rail. The door body is connected to the connecting plate. The connecting plate drives the door body to slide relative to the door frame 412. The driving unit is connected with the connecting plate to drive the connecting plate to slide along the first guide rail. The door body and the connecting plate can be connected through bolts.

The limiting mechanism is connected to the door frame 412 and used for limiting the sliding stroke of the connecting plate. In some embodiments, the limiting mechanism includes an upper limiting block and a lower limiting block which are connected to the door frame 412. The connecting plate is limited to slide back and forth between the upper limiting block and the lower limiting block. In some other embodiments, the limiting mechanism can further include an upper sensing assembly and a lower sensing assembly. The lower sensing assembly includes a lower sensing sheet and a lower sensor. One of the lower sensor and the lower sensing sheet is arranged at the lower end of the door frame 412, and the other one is arranged at the lower end of the connecting plate. Accordingly, the upper sensing assembly includes an upper sensor and an upper sensing sheet. One of the upper sensor and the upper sensing sheet is arranged at the upper end of the door frame 412, and the other one is arranged at the upper end of the connecting plate. Specifically, the upper sensor and the lower sensor are electrically connected with the control mechanism respectively and used for sending stop signals to the driving unit when the connecting plate moves to an upper limit position and a lower limit position, and the driving unit stops working when receiving the stop signals so as to stop the connecting plate at the limit position. In a specific implementation, the lower sensing sheet is connected to the connecting plate and moves with the connecting plate. The lower sensor is connected to the door frame 412. The lower sensor is provided with an insertion slot. When the connecting plate moves to the lower limit position, the lower sensing sheet is inserted into the insertion slot, and the lower sensor sends a stop signal to the control mechanism so that the control mechanism controls the driving unit to stop working.

The driving unit can be the lead screw motor mounted to the door frame 412. The connecting plate is connected with the nut mounting seat of the lead screw motor. The lead screw motor is mounted on the door frame 412 through a motor mounting seat. Specifically, the driving unit can include a driving motor and a lead screw. The lead screw is connected with the connecting plate. In the case that the driving motor is a stepping motor and the lead screw is a rotary lead screw, the motor drives the lead screw to rotate so that the nut mounting seat moves linearly along the lead screw to drive the connecting plate to move. In the case that the driving motor is a linear motor and the lead screw is a telescopic lead screw, the motor drives the lead screw to linearly extend and retract so that the lead screw drives the connecting plate to move up and down. The driving unit can alternatively be an air cylinder and a piston rod. It should be understood that the number of the driving units is two, and the driving units respectively drive the connecting plates of the two lifting units to slide up and down relative to the door frame 412. In this embodiment, the two driving units are simultaneously controlled by the control mechanism to further control the opening and closing of the door body. After the control mechanism receives a door opening instruction, the two driving units output an upward thrust to push the door body to ascend. On the contrary, after the control mechanism receives a door closing instruction, the two driving units output a downward pull force to push the door body to descend.

In the related art, there is a risk of sudden drop when the lifting door is unexpectedly powered off, therefore there is a serious potential safety hazard. Based on this, referring to FIG. 7, in some embodiments, the station door 410 further includes a second guide rail, a weight 413 and a traction assembly. The second guide rail is arranged on the door frame 412, and the second guide rail is parallel to the first guide rail. The weight 413 is slidably connected to the second guide rail. The traction assembly is mounted to the door frame 412. One end of the traction assembly is connected with the weight 413, and the other end of the traction assembly is connected with the connecting plate. When the driving units drive the connecting plate to ascend, the traction assembly pulls the weight 413 to descend. When the driving units drive the connecting plate to descend, the traction assembly pulls the weight 413 to ascend. Furthermore, the traction assembly includes a pulley block 414 and a connecting rope. The pulley block 414 is mounted to the door frame 412, and the connecting rope is wound on the pulley block 414. One end of the connecting rope is connected with the weight 413, and the other end of the connecting rope is connected with the connecting plate. In a specific implementation, the pulley block may be a single pulley, a pulley block composed of two pulleys, a pulley block composed of more pulleys, or in other manners.

The weight of the weight 413 is slightly smaller than the sum of the weight of the door body and the weight of the connecting plate. In this embodiment, when the door body is opened, the driving units output upward thrusts to push the door body to ascend, meanwhile the weight 413 descends to achieve a counterweight effect. On the contrary, when the door body is closed, the driving units output downward pulling forces to pull the door body to descend, meanwhile the weight 413 ascends to achieve the counterweight effect. In this embodiment, in consideration of safety and manual operability in the case of power failure, the weight 413 is provided so that the safety of use and the convenience of maintenance are greatly increased. On one hand, the power required by the driving unit during its driving can be reduced, the volume of the driving unit is reduced, and the structure is more compact. On the other hand, the risk of sudden drop of the door body in the case of unexpected power failure can be avoided, the safe interlock can be achieved in the case of unexpected power failure, and only gently manual lifting is necessary during maintenance, which is convenient to operate.

Further, in some embodiments, a safety limiting block is further arranged under the weight 413. The safety limiting block is connected to the door frame 412 for limiting the weight 413 during its downward movement.

In some embodiments, the door body and two side panels connected with the door body are mainly made of fireproof non-metallic materials, so that the safety during the preparation process of the flammable or explosive sample is improved. Meanwhile, the preparation process is a full-automatic preparation process completed by devices, which reduces the human intervention, therefore the harm of the toxic sample to a human body is reduced. In addition, the door body is a transparent visual window, so that experimenters can intuitively know the experimental conditions in the workstation under the condition that the station door 410 is not opened.

Referring to FIG. 1, in some embodiments, the sample preparation workstation further includes a three-axis calibration support 910 and three identification code calibration plates 920. The three-axis calibration support 910 is connected to an outer wall of the main body 400 and is arranged at one side adjacent to the station door 410. As shown in FIG. 8, the three-axis calibration support 910 includes an X-direction connecting plate 911, a Y-direction connecting plate 912 and a Z-direction connecting plate 913 which are perpendicular to each other in pairs. One end of the Y-direction connecting plate 912 is connected with one end of the X-direction connecting plate 911, and the other end of the Y-direction connecting plate 912 is connected with one end of the Z-direction connecting plate 913. Two of the three identification code calibration plates 920 are respectively arranged at two ends of the X-direction connecting plate 911, and the other identification code calibration plate is arranged at the other end of the Z-direction connecting plate 913. Specifically, each identification code calibration plate 920 has an identification code 921 arranged therein. The identification code 921 is used for locating the main body 400 by a mobile equipment for externally carrying out sample taking and placing operation, which is convenient for the mobile equipment to take samples from the sample exchange chamber 300 and place samples to the sample exchange chamber 300.

In this embodiment, a mobile equipment such as a robot or the like can locate the main body by reading the identification codes arranged in three-dimensional space, therefore the locating precision can be improved.

In conclusion, in this embodiment, full automation of the preparation process can be realized, there is no need for a large number of experimenters to participate in the preparation process, and it is possible to operate uninterruptedly for 24 hours. Thus, the preparation efficiency can be greatly improved, the preparation period can be shortened, and the labor cost can be reduced. Beside it has strong functional compatibility, and different functions can be flexibly and freely matched and combined. The experimental apparatus in the embodiment adopts precise transmission, which improves the dosage accuracy in the sample preparation, reduces the error caused by manual operation, and ensures the precision of the sample preparation.

The present disclosure further provides a sample preparation system which includes a mobile equipment and the sample preparation workstation according to any one of the above-mentioned embodiments. The mobile equipment is used for taking samples from and placing samples to the sample exchange chamber of the sample preparation workstation. Specifically, the mobile equipment can be a mobile robot. By using the mobile robot to transfer samples, manual working intensity can be reduced, the transfer efficiency can be improved, and a full-automatic experiment can be realized. Specifically, the identification codes for three-axis calibration of the sample preparation workstation can assist the mobile equipment in locating the sample preparation workstation.

In addition, at least two sample preparation workstations can be arranged in the sample preparation system. The two sample preparation workstations can realize different or same experimental operations. The mobile equipment can be used for experimental interactions between these sample preparation workstations. For example, the sample preparation workstation A performs powdering experiment, the sample preparation workstation B performs oscillation experiment, and the mobile equipment can transfer the sample after powder adding from the sample preparation workstation A to the sample preparation workstation B for oscillation operation. By using the mobile equipment to realize the interactions between the workstations, human intervention can be reduced to realize full-automatic experiment.

It will be apparent to those skilled in the art that various changes and modifications may be made to the present disclosure, without departing from the spirit and scope of the present disclosure. Thus, if such modifications and variations of the present disclosure fall within the scope of the claims of the present disclosure and their equivalents, the present disclosure is also intended to include such modifications and variations.

1. A sample preparation workstation, comprising:
a preparation platform;
a robotic arm mounted to the preparation platform;
a sample exchange chamber mounted to the preparation platform and used for exchanging a sample before or after experiment with the outside world;
a transfer tool mounted to the robotic arm; and
at least one experimental apparatus mounted to the preparation platform, the robotic arm driving the transfer tool to move so that the transfer tool transfers the sample before experiment in the sample exchange chamber to the experimental apparatus for experiment and transfers the sample after experiment to the sample exchange chamber.

2. The sample preparation workstation of claim 1, comprising a plurality of kinds of said transfer tools, wherein the sample preparation workstation further comprising:
a tool magazine arranged on the preparation platform and used for storing the plurality of kinds of said transfer tools, wherein each kind of the transfer tools is detachably connected with the robotic arm.

3. The sample preparation workstation of claim 1, comprising a plurality of said experimental apparatuses which are distributed around the robotic arm;
wherein the robotic arm is arranged at a central position of the preparation platform, an experimental apparatus far away from the robotic arm is higher than an experimental apparatus close to the robotic arm, and the sample exchange chamber is arranged at an edge position of one side of the preparation platform.

4. The sample preparation workstation of claim 1, wherein the at least one experimental apparatus comprises at least one of a powder adding device, an electromagnetic stirring device, an oscillation device, a dissolved clarification detecting device, a liquid level layering detection device and a filtering device;
wherein the powder adding device is configured to add a powder sample into the sample, the electromagnetic stirring device is configured to stir the sample, the oscillation device is configured to oscillate the sample, the dissolved clarification detecting device is configured to detect a uniformity degree of the sample, the liquid level layering detection device is configured to detect a layering state of the sample, and the filtering device is configured to filter the sample.

5. The sample preparation workstation of claim 2, wherein the transfer tools comprise a container transfer gripper;
wherein the at least one experimental apparatus comprises a rotating module for cap opening and closing, the robotic arm is connected with the container transfer gripper, the container transfer gripper is configured to clamp a cap of a container for containing the sample, the rotating module is configured to clamp a body of the container, and the container transfer gripper and the rotating module are in cooperation with each other to perform a cap opening or closing operation on the container.

6. The sample preparation workstation of claim 2, wherein the transfer tools comprise a liquid transfer module;
wherein the at least one experimental apparatus comprises a solvent storage, the robotic arm is connected with the liquid transfer module, and the robotic arm is configured to drive the liquid transfer module to move and add a solvent in the solvent storage into the sample through the liquid transfer module.

7. The sample preparation workstation of claim 1, further comprising:
a temporary storage holder mounted to the preparation platform, the robotic arm driving the transfer tool to store the sample on the temporary storage holder;
wherein the temporary storage holder comprises at least one layer of storage plate, the storage plate is provided with a first storage position for storing the sample, and the temporary storage holder is arranged at one side of the preparation platform.

8. The sample preparation workstation of claim 7, wherein the temporary storage holder further comprises a connector arranged at the first storage position and configured to limit the sample at the first storage position;
wherein the connector is one of a step pin and an elastic member;
wherein the step pin is configured to be inserted into an insertion hole formed in a bottom of a tray with the sample;
wherein the elastic member is arranged in the limiting slot functioning as the first storage position, and the elastic member can be abutted with a container with the sample and generate elastic deformation when the container is placed in the limiting slot.

9. The sample preparation workstation of claim 2, wherein the sample is contained in a container placed in a tray, the transfer tools comprise a container transfer gripper and a tray transfer gripper;
wherein the sample preparation workstation further comprises a transit holder mounted to the preparation platform, the robotic arm drives the tray transfer gripper to place the tray onto the transit holder, and the robotic arm drives the container transfer gripper to transfer the container in the tray to the experimental apparatus.

10. The sample preparation workstation of claim 9, comprising a plurality of said transit holders with different heights, the higher a transit holder is, the farther it is from the robotic arm;
wherein the transit holder comprises a placing plate;
wherein the placing plate is provided with at least one of a step pin and tray clamping members at both ends of the placing plate, wherein the step pin is configured for being inserted into an insertion hole formed in a bottom of the tray, and the tray clamping members are configured clamping the tray.

11. (canceled)

12. (canceled)

13. The sample preparation workstation of claim 1, wherein the sample exchange chamber comprises:
a support assembly which is connected with the preparation platform;
a holding plate which is connected to the supporting assembly and provided with at least two second storage positions for storing the samples;
a positioner which is connected to the holding plate, corresponds to the second storage position and configured to limit the sample at the second storage position; and
a sensor which is connected to the holding plate, corresponds to the second storage position, and is configured to sense whether a sample is placed at the second storage position.

14. (canceled)

15. The sample preparation workstation of claim 1, further comprising:
a main body which is arranged on the preparation platform, an accommodation space having an opening at one side being defined by the main body and the preparation platform, and the robotic arm, the sample exchange chamber, the transfer tool and the experimental apparatus being all arranged in the accommodation space; and
a station door arranged at the opening;
wherein the sample exchange chamber is arranged at one side close to the station door.

16. The sample preparation workstation of claim 15, further comprising:
a three-axis calibration support which is connected to an outer wall of the main body and arranged at one side close to the station door, wherein the three-axis calibration support comprises an X-direction connecting plate, a Y-direction connecting plate and a Z-direction connecting plate which are perpendicular to each other in pairs, one end of the Y-direction connecting plate is connected with one end of the X-direction connecting plate, and the other end of the Y-direction connecting plate is connected with one end of the Z-direction connecting plate; and
three identification code calibration plates, wherein two of the identification code calibration plates are respectively arranged at two ends of the X-direction connecting plate, and the other identification code calibration plate is arranged at the other end of the Z-direction connecting plate;
wherein each of the identification code calibration plates has an identification code arranged therein, the identification code being used for locating the main body by a mobile equipment for externally carrying out sample taking and placing operation.

17. The sample preparation workstation of claim 15, wherein the station door comprises:
a door frame;
a lifting mechanism which is slidably connected to the door frame;
a driving mechanism which is mounted to the door frame, connected to the lifting mechanism, and configured to drive the lifting mechanism to slide relative to the door frame; and
a door body which is connected to the lifting mechanism and matched with the door frame, the lifting mechanism being configured to drive the door body to slide relative to the door frame.

18. The sample preparation workstation of claim 17, wherein the station door further comprises:
a weight which is slidably connected to the door frame, a sliding direction of the weight being parallel to that of the door body;
a pulley block which is mounted to the door frame; and
a connecting rope which is wound on the pulley block, one end of the connecting rope being connected with the weight, and the other end of the connecting rope being connected with the lifting mechanism;
when the driving mechanism drives the lifting mechanism to ascend, the pulley block and the connecting rope are in cooperation with each other to pull the weight to descend, and when the driving mechanism drives the lifting mechanism to descend, the pulley block and the connecting rope are in cooperation with each other to pull the weight to ascend.

19. The sample preparation workstation of claim 15, further comprising:
a base which is connected to the preparation platform and located under the preparation platform, control devices and electrical devices of the robotic arm and the experimental apparatus being placed in the base; and
a display device which is mounted to the outer wall of the main body and configured for user checking and interaction.

20. The sample preparation workstation of claim 2, wherein the robotic arm is provided with a quick-change male connector, each of the transfer tools is provided with a quick-change female connector, and the quick-change male connector is matched with the quick-change female connector to detachably connect the robotic arm with the transfer tool.

21. The sample preparation workstation of claim 2, wherein the tool magazine is provided with a plurality of placing positions, the number of which corresponds to the number of the transfer tools, wherein the preparation platform is provided with communication holes which are matched with the plurality of placing positions, and the transfer tools can extend into the communication holes when being placed at the placing positions.

22. A sample preparation system, comprising a mobile equipment and a sample preparation workstation according to claim 1, the mobile equipment being configured to take samples from and place samples to the sample exchange chamber of the sample preparation workstation.

23. The sample preparation system of claim 22, comprising at least two said sample preparation workstations, wherein the mobile equipment is further configured for experimental interactions between the at least two said sample preparation workstations.
